(19) United States
(12) Patent Application Publication
(10) Pub. No.: US 2008/0295989 A1
(43) Pub. Date: Dec. 4, 2008

(54) Near-Liquidus Rheomolding of Injectable Alloy

(75) Inventor: Frank CZERWINSKI, Bolton (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 11/755,433

(22) Filed: May 30, 2007

(51) Int. Cl. B22D 17/00; C22C 22/00; G06F 19/00

(52) U.S. Cl. 164/113; 164/303; 420/434; 700/146

(57) ABSTRACT

Disclosed is a process having an operation. The operation includes near-liquidus rheomolding of a molten light-metal alloy being injectable, under pressure, into a mold.

### TECHNICAL FIELD

The present invention generally relates to, but is not limited to, molding systems and molding processes, and more specifically the present invention relates to, but is not limited to, (i) a process having an operation, including near-liquidus rheomolding of a molten light-metal alloy being injectable, under pressure, into a mold, (ii) a system configured to implement a process having an operation, including near-liquidus rheomolding of a molten light-metal alloy being injectable, under pressure, into a mold, and/or (iii) as described in independent claims.

### BACKGROUND

Examples of known molding systems are (amongst others): (i) the HyPET (trademark) Molding System, (ii) the Quadloc (Trademark) Molding System, (iii) the Hylectric (trademark) Molding System, and (iv) the HyMET (trademark) Molding System, all manufactured by Husky Injection Molding Systems (Location: Canada; www.husky.ca).

In conventional casting, the metal is superheated above its liquidus temperature (i.e. the liquidus being the temperature above which the alloy is completely liquid). A minimum superheat is required to ensure that the metal does not solidify prematurely, particularly when molding thin-walled molded articles. Superheating metals which are prone to oxidation has attendant process control challenges to provide and maintain an inert atmosphere.

Articles which are cast from superheated melts often are not sound in that shrinkage porosity and entrapped gases are not uncommon. In addition, their mechanical properties such as tensile strength, yield stress, and elongation suffer, and this is attributed to a microstructure characterized by coarse grains and dendrites.

These problems have been recognized and extensive work has been done to find other ways of processing metal alloys to improve the mechanical properties of cast articles. In particular, through the use of well known semi-solid metal processing techniques molded articles may be produced with much higher mechanical properties as a result of the generation of a favorable alloy microstructure and by reductions in alloy porosity. Moreover, semi-solid processing techniques provide further advantages in that the relatively low temperature of the alloy slurry provides for a longer useful life of the mold than the die-casting method (e.g. lower thermal shock, and reduced amount of liquid-metal corrosion caused by processing fully molten metals), and improved molding accuracy of the molded article. Common semi-solid processing techniques include semi-solid injection molding, rheocasting, and thixoforming.

Semi-solid injection molding (SSIM) is a metals-processing technique that utilizes a single machine for injecting alloys in a semi-solid state into a mold to form an article of nearly net (final) shape. SSIM involves the steps of partial melting of an alloy material by the controlled heating thereof to a temperature between the liquidus and the solidus (i.e. the solidus being the temperature below which the alloy is completely solid) and then injecting the slurry into a molding cavity of an injection mold. SSIM avoids the formation of dendritic features in the microstructure of the molded alloy, which are generally believed to be detrimental to the mechanical properties of the molded article.

U.S. Pat. No. 6,494,703 (Inventor: KESTLE et al; Published: 2002-12-17) discloses a barrel assembly for an injection molding machine that has a barrel coupler which prevents transmittance of axial force from nozzle side barrel portion to rear side barrel portion. The structure and steps of SSIM (described above) appear to be described in more detail in U.S. Pat. No. 6,494,703.

By contrast, rheocasting refers to a process of manufacturing billets or molded articles through casting semi-solid metallic slurries having a predetermined viscosity. In conventional rheocasting, molten alloy is cooled from a superheated state and stirred at temperatures below the liquidus to convert dendritic structures into spherical particles suitable for rheocasting, for example, by mechanical stirring, electromagnetic stirring, gas bubbling, low-frequency, high-frequency, or electromagnetic wave vibration, electrical shock agitation, etc. Thixocasting refers to a process involving reheating billets manufactured through rheocasting back into a metal slurry and casting or forging it to manufacture final articles.

U.S. Pat. No. 5,901,778 (Inventor: ICHIKAWA et al; Published: Dec. 17, 1999) discloses an improved rheocasting method and extruder apparatus for producing a semi-solid metal alloy slurry having a solids content between 1 and 50% that is characterized by structure and steps whereby molten metallic alloy material is introduced into an agitation chamber, that is heated about 100 degree C. higher than a liquidus temperature of the molten metallic material, wherein the alloy is cooled and agitated by a cooled screw-shaped stirring rod, having a temperature below a temperature of the semi-solid, to produce the semi-solid slurry.

United States Patent Application Number 2004/0173337 (Inventor: YURKO et al; Published: Sep. 9, 2004) discloses an improved rheocasting method and apparatus for producing a non-dendritic, semi-solid metal alloy slurry having a solids content of about 10% to about 65% that is characterized by structure and steps whereby problems associated with accumulation and removal of metal from surfaces of the apparatus contacting the slurry are reduced or eliminated.

United States Patent Application Number 2004/0055726 (Inventor: HONG et al; Published: Mar. 25, 2004) discloses a rheocasting method and apparatus for die casting molded articles that is characterized by structure and steps for applying an electromagnetic field to stir a molten metal as it is being loaded into a slurry forming portion of a shot sleeve whereby the slurry is stirred until cooled below its liquidus temperature prior to its transfer to a casting portion of the shot sleeve.

United States Patent Application 2004/0055727 (Inventor: HONG et al; Published: Mar. 25, 2004) discloses manufacturing billets for thixocasting.

United States Patent Application 2004/0055734 (Inventor: HONG et al; Published: Mar. 25, 2004) discloses manufacturing metallic materials for rheocasting or thixoforming.

United States Patent Application 2004/0055735 (Inventor: HONG et al; Published: Mar.25, 2004) discloses manufacturing a semi-solid metallic slurry.

U.S. Pat. No. 6,311,759 (Inventor: TAUSIG et al; Published: Nov. 6, 2001) discloses a process for producing a feedstock billet material that is characterized in that it is produced from a melt at substantially its liquidus temperature whereby a microstructure of the feedstock is rendered especially suitable for subsequent thixocasting in the semi-solid range of 60 to 80% primary solids. This patent is significant in that it recognizes that metal alloys cast from at a near liquidus temperature will result in a favorable grain structure characterized by primary grains that are equi-axed and globular with no dendrites.

The process of SSIM is however generally preferred as it provides for several important advantages relative to the other semi-solid processing techniques. The benefits of SSIM include an increased design flexibility of the final article, a low-porosity article as molded (i.e., without subsequent heat treatment), a uniform article microstructure, and articles with mechanical and surface-finish properties that are superior to those made by conventional casting. Also, because the entire process takes place in one machine and in an ambient environment of inert gas (e.g., argon), alloy evaporation and oxidation can be nearly eliminated. The SSIM process also provides for energy savings in that it does not require the heating of the alloy above its liquidus temperature. Although a 5-60% solids content is generally understood to be the working range for SSIM, it is also generally understood that practical guidelines recommend a range of 5-10% solids for injection molding thin-walled articles (i.e., articles with fine features) and 25-30% for articles with thick walls.

U.S. Pat. No. 5,040,589 (Inventor: BRADLEY et al; Published: Aug. 20, 1991) discloses injection molding of metal alloys such as magnesium alloys, with improved yield, productivity, and mold life. The practical guidelines (described above) are identified in U.S. Pat. No. 5,040,589.

United States Patent Application 2003/0230392 (Inventor: CZERWINSKI et al; Published: Dec. 18, 2003) discloses a range of percentage of solids in SSIM processing that can be advantageously extended into an ultra-high solids range between 60 and 85%.

The lower limit of 5% solids fraction has been sustained by those skilled in the art because of a belief that to lower the solids fraction any further would obviate any advantages achieved by semi-sold processing. In particular, with a low or non-existent solids content, the fluidity of the alloy is expected to increase, resulting in an increase in turbulence in the flow front thereof as the molding cavity is being filled, and thereby increasing the likelihood of porosity and entrapped gases in the final article.

Notwithstanding the foregoing, it is known to configure structure and steps for SSIM processing with a percentage of solids as low as 2% under certain conditions.

U.S. Pat. No. 5,979,535 (Inventor: SAKAMOTO et al; Published: Nov. 9, 1999) discloses a method for injection molding a molded article having both lower and higher solid fraction portions therein, the method characterized in that structure and steps are provided for establishing a temperature distribution in the semi-molten slurry in the direction of injection, by the controlled heating thereof in an extruder cylinder, whereby the slurry contemporaneously includes a low and a high solids fraction portions for sequential injection into the molding cavity. In a cited example, an orifice holder is molded in which a high strength head portion is formed from a melt portion having about 2% solids whereas a more accurately molded threaded portion is formed from a melt portion having about 10% solids.

However, the molding of thin-walled molded articles, particularly those having a thickness below 2 mm, using SSIM at typical low levels of solids fraction (i.e. 5%) can be problematic because of premature alloy solidification that results from the reduced fluidity of the alloy metal, relative to die casting, and because of the high thermal conductivity of typical molding alloys (e.g. Magnesium alloy AZ91D).

U.S. Pat. No. 6,619,370 (Inventor: SAKAMOTO et al; Published: Sep. 16, 2003) discloses solving the problems of molding thin-walled molded articles using SSIM. In particular, structure and steps are provided for increasing the fluidity of the semi-molten melt and for providing increased degassing of the molding cavity. It is stated therein that the solid fraction of the semi-molten metal slurry must be set within a range exceeding 3% and below 40% to avoid excessive warping of the thin-walled molded article.

### SUMMARY

According to a first aspect of the present invention, there is provided a process, having an operation, including near-liquidus rheomolding of a molten light-metal alloy being injectable, under pressure, into a mold.

According to a second aspect of the present invention, there is provided a process, including: an operation, including receiving a solidified light-metal alloy; an operation, including heating the solidified light-metal alloy associated with the operation above a liquidus temperature of the molten light-metal alloy, the solidified light-metal alloy becoming a molten light-metal alloy; an operation, including cooling the molten light-metal alloy associated with the operation between the liquidus temperature and a solidus temperature of the molten light-metal alloy, so that the molten light-metal alloy includes a solids fraction content of less than 5%; and an operation, including injecting, under pressure, the molten light-metal alloy resulting from the operation into a mold cavity of a mold so that the molten light-metal alloy may become solidified in the mold.

According to a third aspect of the present invention, there is provided a system, including: a receiver assembly configured to perform an operation, including receiving a solidified light-metal alloy; a heater assembly configured to perform: (i) an operation, including heating the solidified light-metal alloy associated with the operation above a liquidus temperature of the molten light-metal alloy, the solidified light-metal alloy becoming a molten light-metal alloy, and (ii) an operation, including cooling the molten light-metal alloy associated with the operation between the liquidus temperature and a solidus temperature of the molten light-metal alloy, so that the molten light-metal alloy includes a solids fraction content of less than 5%; and an injector assembly ) configured to perform an operation, including injecting, under pressure, the molten light-metal alloy resulting from the operation into a mold cavity of a mold so that the molten light-metal alloy may become solidified in the mold.

According to a fourth aspect of the present invention, there is provided a material input of the process as described above.

According to a fifth aspect of the present invention, there is provided an article made by the process as described above.

According to a sixth aspect of the present invention, there is provided a system operable according to the process as described above.

According to a seventh aspect of the present invention, there is provided a computer program product for carrying a computer program embodied in a computer-readable medium being configured to instruct a controller to direct a system to perform, at least in part, the process as described above.

According to a eighth aspect of the present invention, there is provided a controller including a computer program product for carrying a computer program embodied in a computer-readable medium adapted to perform, at least in part, the molding-system process as described above.

A technical effect, amongst other technical effects, of the aspects of the present invention is the possibility to manufacture of an article having fine homogeneous microstructure, low porosity and generally-improved properties.

### DESCRIPTION OF THE DRAWINGS

A better understanding of the non-limiting embodiments of the present invention (including alternatives and/or variations thereof) may be obtained with reference to the detailed description of the non-limiting embodiments of the present invention along with the following drawings, in which:

FIG. 1 depicts a schematic representation of a process 100 according to a first non-limiting embodiment;

FIG. 2 depicts a schematic representation of a material input 2 of the process 100 of FIG. 1, an article 4 made by the process 100 of FIG. 1, a system 200 operable according to the process 100 of FIG. 1, a controller 220 for directing the system 200 to perform, at least in part, the process 100 of FIG. 1, and a computer program product 222 for instructing the controller 220 to direct the system 200 to perform, at least in part, the process 100 of FIG. 1; and

FIG. 3 depicts a schematic representation of a temperature diagram 300 associated with the process 100 of FIG. 1.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### REFERENCE NUMERALS USED IN THE DRAWINGS

The following is a listing of the elements designated to each reference numeral used in the drawings:
material input, 2
article, 4
process, 100
operation, 101
first operation, 102
second operation, 104
third operation, 106
fourth operation, 108
system, 200
receiver assembly, 202
heater assembly, 204
injector assembly, 206
extruder, 207
hopper, 210
feed throat, 212
barrel assembly, 214
screw, 216
motor, 218
controller, 220
computer program product, 222
machine nozzle, 224
mold, 250
stationary mold portion, 252
movable mold portion, 254
stationary platen, 260
movable platen, 262
clamp assembly, 264

### DETAILED DESCRIPTION OF THE NON-LIMITING EMBODIMENTS

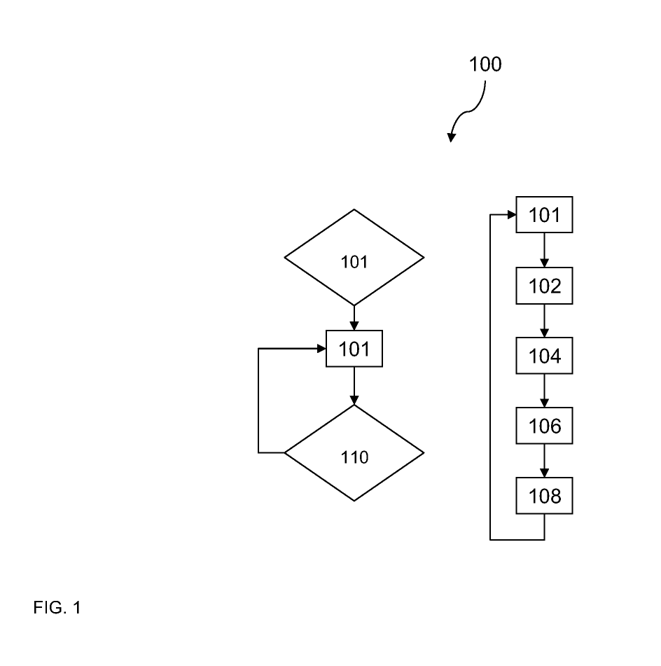

FIG. 1 depicts the schematic representation of the process 100 according to the first non-limiting embodiment. The process 100 has an operation 101 that includes near-liquidus rheomolding of a molten light-metal alloy being injectable, under pressure, into a mold. According to a non-limiting variant, the process 100 includes: (i) a first operation 102, (ii) a second operation 104, (iii) a third operation 106, and (iv) a fourth operation 108. According to another non-limiting variant, the operation 101 includes: the first operation 102, the second operation 104, the third operation 106, and the fourth operation 108. The first operation 102 includes receiving a solidified light-metal alloy (such as, magnesium, aluminum and/or zinc). The second operation 104 includes heating the solidified light-metal alloy associated with the first operation 102 above a liquidus temperature of the molten light-metal alloy so that the solidified light-metal alloy becomes a molten light-metal alloy. The third operation 106 includes cooling the molten light-metal alloy associated with the second operation 104 between the liquidus temperature and a solidus temperature of the molten light-metal alloy, so that the molten light-metal alloy includes a solids fraction content of less than 5%. It will be appreciated that cooling of the molten light-metal alloy may be achieved by lowering the temperature (that is, by shutting off heaters used to heat the molten light-metal alloy, etc). The fourth operation 108 includes injecting, under pressure, the molten light-metal alloy resulting from the third operation 106 into a mold cavity of a mold so that the molten light-metal alloy may become solidified in the mold. According to a non-limiting variants, (i) the solidified light-metal alloy includes an AZ91D alloy having a liquidus temperature of nominally 595° C., (ii) the solidified light-metal alloy includes a zinc alloy, (iii) the solidified light-metal alloy includes a zinc alloy. The molten light-metal alloy is understood to be a molding material.

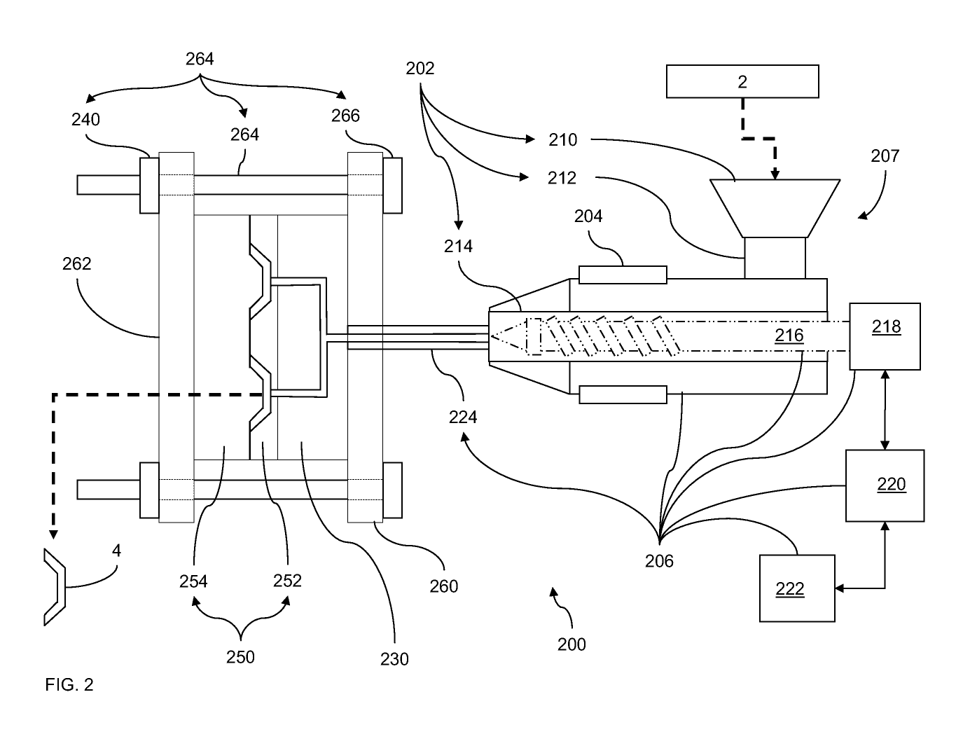

FIG. 2 depicts the schematic representation of: (i) the material input 2 of the process 100 of FIG. 1, (ii) the article 4 made by the process 100, (iii) the system 200 operable according to the process 100, (iv) the controller 220 for directing the system 200 to perform, at least in part, the process 100, and (v) the computer program product 222 for instructing the controller 220 to direct the system 200 to perform, at least in part, the process 100. It will be appreciated that the system 200 includes components that are known to persons skilled in the art, and these known components will not be described here; these known components are described, at least in part, in the following text books (by way of example): (i) “Injection Molding Handbook” by Osswald/Turng/Gramann (ISBN: 3-446-21669-2; publisher: Hanser), (ii) “Injection Molding Handbook” by Rosato and Rosato (ISBN: 0-412-99381-3; publisher: Chapman & Hill), and/or (iii) “Injection Molding Systems” 3^{rd} Edition by Johannaber (ISBN 3-446-17733-7). According to a non-limiting variant, the system 200 includes an injection molding system. The system 200 includes: (i) a receiver assembly 202, (ii) a heater assembly 204, and (iii) an injector assembly 206. The receiver assembly 202 is configured to perform the first operation 102, including receiving the solidified light-metal alloy. Preferably, the solidified light-metal alloy is received in the form of chips; it will be appreciated that the solidified light-metal alloy may be delivered to the receiver assembly 202 as a billet of material (that is, in a log-type form). The heater assembly 204 is coupled to the receiver assembly 202. The heater assembly 204 is configured to perform: (a) the second operation 104, and (b) the third operation 106. The second operation 104 includes heating the solidified light-metal alloy associated with the first operation 102 above the liquidus temperature of the molten light-metal alloy; as a result, the solidified light-metal alloy becomes (or is transformed into) the molten light-metal alloy. The third operation 106 includes cooling the molten light-metal alloy associated with the second operation 104 between the liquidus temperature and the solidus temperature of the molten light-metal alloy; and as a result of the second operation 104, the molten light-metal alloy includes a solids fraction content of less than 5%. The injector assembly 206 is coupled to the the receiver assembly 202. The injector assembly 206 is configured to perform the fourth operation 108 that includes injecting, under pressure, the molten light-metal alloy resulting from the third operation 106 into the mold cavity of a mold 250 so that the molten light-metal alloy may become solidified in the mold 250.

According to a non-limiting variant, the system 200 includes an extruder 207. The extruder 207 includes: (i) the receiver assembly 202, (iii) the heater assembly 204 and (iii) the injector assembly 206. The receiver assembly 202 includes: (i) a hopper 210, (ii) a feed throat 212, and (iii) a barrel assembly 214. The feed throat 212 is coupled to the hopper 210.The barrel assembly 214 is connected with the feed throat 212. The hopper 210, the feed throat 212 and the barrel assembly 214 are configured to perform the first operation 102, including receiving the solidified light-metal alloy.

The heater assembly 204 is coupled to the barrel assembly 214. The heater assembly 204 is configured to perform: (i) the second operation 104, and (ii) the third operation 106. The second operation 104 includes heating the solidified light-metal alloy associated with the first operation 102 above the liquidus temperature of the molten light-metal alloy; and as a result, the solidified light-metal alloy becomes the molten light-metal alloy. The third operation 106 includes cooling the molten light-metal alloy associated with the second operation 104 between the liquidus temperature and the solidus temperature of the molten light-metal alloy, so that the molten light-metal alloy includes a solids fraction content of less than 5%.

The injector assembly 206 includes: (i) a machine nozzle 224, (ii) a screw 216, (iii) a motor 218, and (iv) a controller 220. The machine nozzle 224 is connected with an output of the barrel assembly 214. The machine nozzle 224 is configured to convey the molten light-metal alloy away from the barrel assembly 214 toward the mold 250. The barrel assembly 214 is configured to receive the screw 216. The motor 218 is coupled to the screw 216. The motor 218 is configured to drive (rotate, translate) the screw 216. The motor 218 may be a combination of electrical components and hydraulic components. The controller 220 includes a computer program product 222 for carrying a computer program. The computer program is embodied in a computer-readable medium. The computer-readable medium is adapted to direct the controller 220 to control the motor 218 so that the motor 218 may actuate the screw 216 so as to perform the fourth operation 108 that includes injecting, under pressure, the molten light-metal alloy resulting from the third operation 106 into the mold cavity of the mold 250 so that the molten light-metal alloy may become solidified in the mold 250.

According to a non-limiting variant, the system 200 further includes: (i) a stationary platen 260, (ii) a movable platen 262, and (iii) a clamp assembly 264. The stationary platen 260 is configured to support a stationary mold portion 252 of the mold 250. The movable platen 262 configured to support a movable mold portion 254 of the mold 250. The movable platen 262 is movable relative to the stationary platen 260 so as to close the stationary mold portion 252 against the movable mold portion 254. The clamp assembly 264 is configured to apply (after the mold portions 252, 254 are closed against each other) a clamping force to the stationary platen 260 and the movable platen 262 so that the stationary mold portion 252 remains closed against the movable mold portion 254 as the mold 250 receives, under pressure, the molten light-metal alloy from the injector assembly 206.

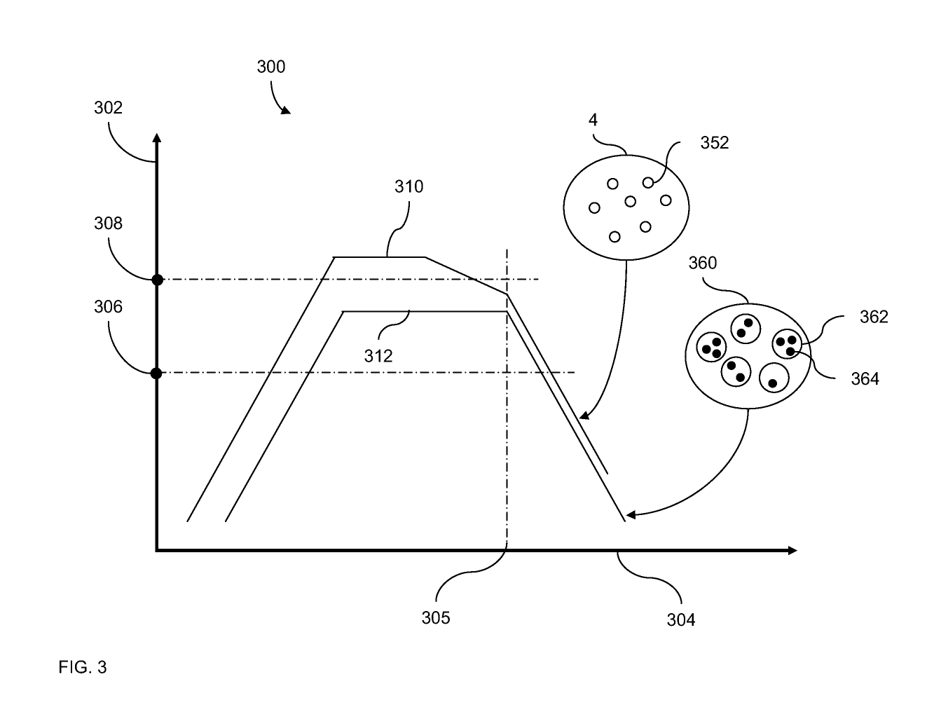

FIG. 3 depicts the schematic representation of the temperature diagram 300 associated with the process 100 of FIG. 1. A temperature axis 302 represents temperature across a vertically-extending axis (that is, increasing temperature to the top of FIG. 3). A point 306 represents the solidus temperature of the light-metal alloy (that is, below the solidus temperature, the alloy remains in a solid state). A point 308 represents the liquidus temperature of the light-metal alloy (that is, above the liquidus temperature, the alloy remains in a primarily liquid state). It will be appreciated that between the solidus temperature and the liquidus temperature, the alloy remains in a slurry state (that is, the alloy has some solid components and a liquid componet). A time axis 304 represents time that extends across a horizontally-asligned axis (that is, time increasing to the right of FIG. 3). A point 305 represents the time at injection of the light-metal alloy into the mold cavity. A curve 310 represents the heating treatment given or imparted to the light-metal alloy according to the process 100 of FIG. 1; as a result of that heating treatment, the article 4 is manufactured. A curve 312 represents the heating treatment that was imparted to an alloy, in which the heating treatment does not use the process 100; as a result of that heating treatment, a solidified article 360 is manufactured. The article 4 that is made by the process 100 is shown (in a solidified state and removed from the mold cavity) as having a microstructure that includes a fine solid particle 352 (actually, a plurality of fine solid particles). In sharp contrast, a solidified article 360 is made according not to the process 100 but according to the a process of injecting a slurry of molten alloy (that is, the molten alloy has a temperature that does not exceed the liquidus temperature of the alloy; specifically the alloy is partially melted before being injected into a mold cavity); the solidified article 360 has a microstructure that includes a course particle 362 that includes entrapped, solidified liquid.

A technical effect, amongst other technical effects, of the aspects of the non-limiting embodiment is the possibility to manufacture an article having fine homogeneous microstructure, low porosity and generally-improved properties. If the solidified molten light-metal alloy is: (i) heated to above the liquidus temperature of the solidified molten light-metal alloy, (ii) then cooled to the sub-liquidus temperature (that is, below liquidus temperature of the alloy but above solidus temperature of the alloy), and (iii) then injected into a mold cavity, the solidified article 4, which is extracted from the mold cavity, includes (precipitated) fine solid particles 352, in which the range of the size of the precipitated fine solid particles 352 are in the range at and/or below nominally 30 micrometers.

In sharp contrast, if (i) the temperature of the molten light-metal alloy is not allowed to exceed past the liquidus temperature, and (ii) the molten light-metal alloy is injected in to the mold cavity, the solidified article 360 (which is removed from the mold cavity) includes precipitated solid particles (also called sub-regions) 362, in which the range of the size of the precipitated solid particles (larger-sized particles) are in the range between nominally 80 micrometers to nominally 100 micrometers, and the solidified article includes sub-regions 364 of solidified, entrapped liquid.

The technical effect of heating the molten light-metal alloy past liquidus temperature (according to the process 100) is that a thin walled particle may be molded; that is, it will be easier for finer-sized particles to pass through a gate leading into the mold cavity if the process 100 is used. In sharp contrast, if the process 100 is not used, larger-sized particles may jam up in the gate leading into the mold cavity, which causes downtime for the system 200 of FIG. 2 and/or a reduction of process efficiencies associated with the process 100 of FIG. 1.

The description of the non-limiting embodiments provides non-limiting examples of the present invention; these non-limiting examples do not limit the scope of the claims of the present invention. The non-limiting embodiments described are within the scope of the claims of the present invention. The non-limiting embodiments described above may be: (i) adapted, modified and/or enhanced, as may be expected by persons skilled in the art, for specific conditions and/or functions, without departing from the scope of the claims herein, and/or (ii) further extended to a variety of other applications without departing from the scope of the claims herein. It is to be understood that the non-limiting embodiments illustrate the aspects of the present invention. Reference herein to details and description of the non-limiting embodiments is not intended to limit the scope of the claims of the present invention. Other non-limiting embodiments, which may not have been described above, may be within the scope of the appended claims. It is understood that: (i) the scope of the present invention is limited by the claims, (ii) the claims themselves recite those features regarded as essential to the present invention, and (ii) preferable embodiments of the present invention are the subject of dependent claims. Therefore, what is to be protected by way of letters patent are limited only by the scope of the following claims:

What is claimed is:

1. A process, comprising:
an operation, including near-liquidus rheomolding of a molten light-metal alloy being injectable, under pressure, into a mold.

2. The process of claim 1, further comprising:
a first operation, including receiving a solidified light-metal alloy.

3. The process of claim 2, further comprising:
a second operation, including heating the solidified light-metal alloy associated with the first operation above a liquidus temperature of the solidified light-metal alloy, the solidified light-metal alloy becoming the molten light-metal alloy.

4. The process of claim 3, further comprising:
a third operation, including cooling the molten light-metal alloy associated with the second operation between the liquidus temperature and a solidus temperature of the molten light-metal alloy, so that the molten light-metal alloy includes a solids fraction content of less than 5%.

5. The process of claim 4, further comprising:
a fourth operation, including injecting, under pressure, the molten light-metal alloy resulting from the third operation into a mold cavity of the mold so that the molten light-metal alloy may become solidified in the mold.

6. A process, comprising:
a first operation, including receiving a solidified light-metal alloy;
a second operation, including heating the solidified light-metal alloy associated with the first operation above a liquidus temperature of the solidified light-metal alloy, the solidified light-metal alloy becoming a molten light-metal alloy;
a third operation, including cooling the molten light-metal alloy associated with the second operation between the liquidus temperature and a solidus temperature of the molten light-metal alloy, so that the molten light-metal alloy includes a solids fraction content of less than 5%; and
a fourth operation, including injecting, under pressure, the molten light-metal alloy resulting from the third operation into a mold cavity of a mold so that the molten light-metal alloy may become solidified in the mold.

7. The process of claim 1, wherein the molten light-metal alloy includes an AZ91D alloy, and the liquidus temperature of the AZ91D alloy is nominally 595° C.

8. A material input of the process of claim 1.

9. An article made by the process of claim 1.

10. A system operable according to the process of claim 1.

11. A computer program product for carrying a computer program embodied in a computer-readable medium being configured to instruct a controller to direct a system to perform, at least in part, the process of claim 1.

12. A controller including a computer program product for carrying a computer program embodied in a computer-readable medium adapted to perform, at least in part, the process of claim 1.

13. A system, comprising:
a receiver assembly configured to perform a first operation, including receiving a solidified light-metal alloy;
a heater assembly configured to perform: (i) a second operation, including heating the solidified light-metal alloy associated with the first operation above a liquidus temperature of the solidified light-metal alloy, the solidified light-metal alloy becoming a molten light-metal alloy, and (ii) a third operation, including cooling the molten light-metal alloy associated with the second operation between the liquidus temperature and a solidus temperature of the molten light-metal alloy, so that the molten light-metal alloy includes a solids fraction content of less than 5%; and
an injector assembly configured to perform a fourth operation, including injecting, under pressure, the molten light-metal alloy resulting from the third operation into a mold cavity of a mold so that the molten light-metal alloy may become solidified in the mold.

14. The system of claim 13, wherein:
the receiver assembly is coupled to the heater assembly ; and
the receiver assembly is coupled to the injector assembly.

15. A system, comprising:
an extruder including:
(i) a receiver assembly, including:
a hopper;
a feed throat coupled to the hopper;
a barrel assembly connected with the feed throat, the hopper, the feed throat and the barrel assembly configured to perform a first operation, including receiving a solidified light-metal alloy;
(ii) a heater assembly coupled to the barrel assembly, the heater assembly configured to perform: (i) a second operation, including heating the solidified light-metal alloy associated with the first operation above a liquidus temperature of the solidified light-metal alloy, the solidified light-metal alloy becoming a molten light-metal alloy, and (ii) a third operation, including cooling the molten light-metal alloy associated with the second operation between the liquidus temperature and a solidus temperature of the molten light-metal alloy, so that the molten light-metal alloy includes a solids fraction content of less than 5%; and
(iii) an injector assembly, including:
a machine nozzle connected with an output of the barrel assembly, the machine nozzle configured to convey the molten light-metal alloy away from the barrel assembly toward a mold;
a screw, the barrel assembly configured to receive the screw; and
a motor coupled to the screw, the motor configured to drive the screw; and
a controller including:
a computer program product for carrying a computer program embodied in a computer-readable medium adapted to direct the controller to control the motor so that the motor may actuate the screw so as to perform a fourth operation, including injecting, under pressure, the molten light-metal alloy resulting from the third operation into a mold cavity of the mold so that the molten light-metal alloy may become solidified in the mold.

16. The system of claim 15, further comprising:
a stationary platen configured to support a stationary mold portion of the mold;
a movable platen configured to support a movable mold portion of the mold, the movable platen being movable relative to the stationary platen so as to close the stationary mold portion against the movable mold portion; and
a clamp assembly configured to apply a clamping force to the stationary platen and the movable platen so that the stationary mold portion remains closed against the movable mold portion as the mold receives the molten light-metal alloy.
